(19) United States
(12) Patent Application Publication
(10) Pub. No.: US 2016/0286302 A1
(43) Pub. Date: Sep. 29, 2016

(54) RANGE SWITCHING EARPHONE

(71) Applicant: Jetvox Acoustic Corp., Taoyuan City (TW)

(72) Inventors: To-Teng HUANG, Taoyuan (TW); Hao-Hsiang CHI, Taoyuan (TW)

(21) Appl. No.: 14/755,656

(22) Filed: Jun. 30, 2015

(30) Foreign Application Priority Data
Mar. 27, 2015 (TW) 104204732

(51) Int. Cl. H04R 1/24; H04R 3/12; H04R 17/00; H04R 1/10

(52) U.S. Cl. CPC H04R 1/24; H04R 1/1041; H04R 3/12; H04R 1/1016; H04R 17/00

(57) ABSTRACT

A range switching earphone includes an earphone housing, a low frequency speaker, a high frequency speaker, a circuit adaptation module, and a control unit. The low frequency speaker, the high frequency speaker, and the circuit adaptation module are in the earphone housing. The circuit adaptation module is electrically connected to the low frequency speaker and the high frequency speaker. The control unit is connected to the circuit adaptation module for switching on or off of the high frequency speaker or for switching filtering modes of a filtering unit in the circuit adaptation module. Therefore, different frequency response can be achieved with the same earphone, thereby satisfying requirements or tastes of users for listening music of different styles or in different circumstances. Thus, both classical music lovers and game players who want to have an immersed sense can all be satisfied by the range switching earphone.

### CROSS-REFERENCES TO RELATED APPLICATIONS

This non-provisional application claims priority under 35 U.S.C. §119(a) on Patent Application No. 104204732 filed in Taiwan, R.O.C. on 2015 Mar. 27, the entire contents of which are hereby incorporated by reference.

### BACKGROUND

1. Technical Field

The instant disclosure relates to the earphone audio field, and in particular, to an earphone capable of changing a range by switching frequency responses.

2. Related Art

In the market, most earphones for consumer electronic products such as mobile phones, tablet computers, and MP3 players are of the moving-coil type. A moving-coil earphone usually includes a vibrating diaphragm, a voice coil and a permanent magnet. The voice coil is located in the permanent magnet. When the voice coil is driven by an electric current, a magnetic field is generated to interact with a magnetic force of the permanent magnet to drive the vibrating diaphragm to vibrate. An audio signal is transmitted to the voice coil through a connection line and is converted into a sound wave to be outputted.

Considering the general purpose and the cost, a moving-coil earphone with a single vibrating diaphragm is usually adopted. The general purpose earphone has an advantage of a wider frequency band but has a common disadvantage of a poor resolution effect for mid- and high-pitch frequencies. It can be seen from spectral analysis that, a response in a high pitch region is poor so that the location and space sense of the sound and the response cannot be clearly resolved. Although such earphones are generic, users have different preferences of using earphones. For example, someone is accustomed to using the earphone to listen classical music, while someone is accustomed to using the earphone to play games in a mobile phone or a tablet computer. Thus, there is a need for an earphone capable of satisfying various requirements.

### SUMMARY

The objective of the instant disclosure is to provide a range switching earphone. According to one embodiment, the range switching earphone comprises an earphone housing, a low frequency speaker, a high frequency speaker, a circuit adaptation module, and a control unit. The low frequency speaker and the high frequency speaker are both disposed in the earphone housing. The circuit adaptation module is electrically connected to the low frequency speaker and the high frequency speaker. The control unit is connected to the circuit adaptation module for controlling turn-on or turn-off of the high frequency speaker.

In an embodiment, the circuit adaptation module includes a switch unit and a signal receiving unit. The signal receiving unit is electrically connected to the switch unit and the control unit. The control unit is capable of being activated to generate a switching signal. The signal receiving unit receives the switching signal and controls turn-on or turn-off of the switch unit, to switch a connection of the circuit adaptation module and the high frequency speaker between an open circuit and a closed circuit. In this manner, the turn-on or turn-off of the switch unit is controlled by an electrical signal.

In an embodiment, the circuit adaptation module includes a switch unit The switch unit is connected to the control unit. The control unit controls turn-on or turn-off of the switch unit, to switch a connection of the circuit adaptation module and the high frequency speaker between an open circuit and a closed circuit. In this manner, the turn-on or turn-off of the switch unit is controlled mechanically.

In an embodiment, the control unit is disposed on a control bar. The control bar is disposed on a connection line and the connection line is further connected to the circuit adaptation module. In another embodiment, the control unit is disposed on the earphone housing.

Another objective of the instant disclosure is to provide a range switching earphone. In one embodiment, the range switching earphone comprises an earphone housing, a low frequency speaker, a high frequency speaker, a circuit adaptation module, and a control unit. The low frequency speaker and the high frequency speaker are both disposed in the earphone housing. The circuit adaptation module is electrically connected to the low frequency speaker and the high frequency speaker, and the circuit adaptation module includes a filtering unit. The filtering unit has a filtering mode and a non-filtering mode. The control unit is connected to the filtering unit for selectively controlling the filtering unit to be in the filtering mode or the non-filtering mode.

In an embodiment, the control unit is electrically connected to the filtering unit through a signal control unit and controls the filtering unit to be in the filtering mode or the non-filtering mode through an electrical signal. In another embodiment, the control unit is connected to the filtering unit and mechanically controls the filtering unit to be in the filtering mode or the non-filtering mode.

The objective of the range switching earphone of the embodiment is to provide a user with switching selection, for controlling turn-on or turn-off of the high frequency speaker or controlling the filtering unit to be in the filtering mode or the non-filtering mode, thereby adjusting the frequency range or range extent. Therefore, different frequency response can be achieved with the same earphone, thereby satisfying requirements or tastes of users for listening music of different styles or in different circumstances. Therefore, classical music lovers who desire to have a good effect of full-voice-frequency resolution and game players who desire to have improved immersed sense through low frequencies can all be satisfied by the range switching earphone of the present invention.

### BRIEF DESCRIPTION OF DRAWINGS

FIG. 1 illustrates an exploded view of a range switching earphone according to a first embodiment of the instant disclosure.

FIG. 2 illustrates an exploded view of a range switching earphone according to a second embodiment of the instant disclosure.

FIG. 3 is a schematic diagram of units of the range switching earphone according to the first embodiment of the instant disclosure.

FIG. 4 is a schematic diagram of units of the range switching earphone according to the second embodiment of the instant disclosure.

FIG. 5 is a schematic diagram of units of a range switching earphone according to a third embodiment of the instant disclosure.

FIG. 6 is a schematic diagram of units of a range switching earphone according to a fourth embodiment of the instant disclosure.

### DETAILED DESCRIPTION

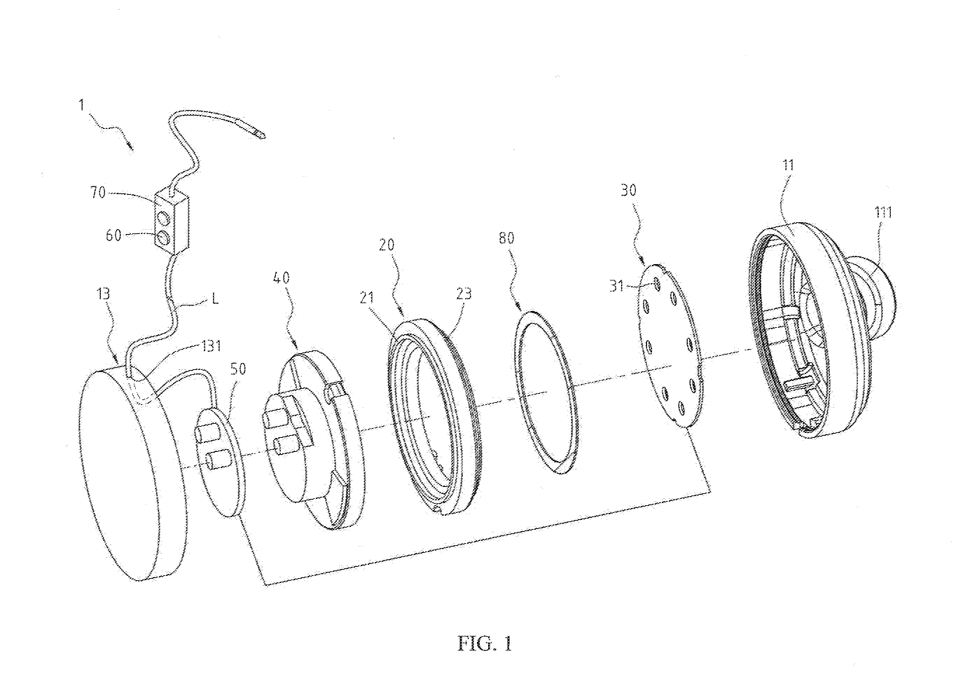

Referring to FIG. 1, an exploded view of a range switching earphone according to a first embodiment of the instant disclosure is shown. As shown in FIG. 1, the range switching earphone 1 according to the first embodiment of the instant disclosure comprises an earphone housing 10, a high frequency speaker 30, a low frequency speaker 40, a circuit adaptation module 50, and a control unit 60.

As shown in the embodiment in FIG. 1, the earphone housing 10 includes a first housing 11 and a second housing 13. The first housing 11 is combined with the second housing 13 to form an accommodation space therebetween. The first housing 11 is formed with an in-ear portion 111 to correspond to an ear canal of a wearer. The in-ear portion 111 may be provided with voice emitting holes (not shown) for the sound to penetrate. However, the form of the above earphone housing is only intended for exemplary illustration but not for limitation.

The high frequency speaker 30 and the low frequency speaker 40 are both disposed in the earphone housing 10 and electrically connected to the circuit adaptation module 50. In this embodiment, the high frequency speaker 30 and the low frequency speaker 40 may be disposed in the accommodation space between the first housing 11 and the second housing 13 by a holder 20. The holder 20 may be connected to the first housing 11 or the second housing 13 in a manner that an outer wall of the holder 20 is engaged with the first housing 11 or the second housing 13, a tenon on the first housing 11 or the second housing 13 is used for engaging, or a thread of the holder 20 is screwed with a thread of the first housing 11 or the second housing 13. The above description is only intended for exemplary illustration but not for limitation.

The low frequency speaker 40 is connected to a first side 21 of the holder 20 and electrically connected to the circuit adaptation module 50. When the circuit adaptation module 50 is driven by an electrical signal, the low frequency speaker 40 is actuated to vibrate to generate a sound wave. The low frequency speaker 40 is a moving-coil loudspeaker or a moving-iron loudspeaker. The high frequency speaker 30 is connected to a second side 23 of the holder 20, where the second side 23 is opposite to the first side 21 and faces the first housing 11. The high frequency speaker 30 is electrically connected to the circuit adaptation module 50. When the circuit adaptation module 50 is driven by an electrical signal, the high frequency speaker 30 is actuated to vibrate to generate a sound wave. Further, the high frequency speaker 30 is connected to the second side 23 of the holder 20 through an adhesive sheet 80.

Generally, the high frequency speaker 30 may be implemented as a piezoelectric ceramic loudspeaker. As shown in FIG. 1, the high frequency speaker 30 may be of a disc-like shape, and voice penetrating holes 31 arranged annularly are provided in the high frequency speaker 30 so that a voice wave generated by the low frequency speaker 40 can penetrate outwards.

The circuit adaptation module 50 is electrically connected to the low frequency speaker 40, the high frequency speaker 30 and a connection line L, and after receiving an audio signal from an external connection, converts the audio signal into an electrical signal to actuate the low frequency speaker 40 and the high frequency speaker 30. Further, the connection line L may be fixed by passing through an opening 131 of the second housing 13.

The control unit 60 of the range switching earphone 1 according to the first embodiment of the instant disclosure is disposed on a control bar 70. The control bar 70 is disposed on the connection line L and the connection line L is further electrically connected to the circuit adaptation module 50. In this embodiment, the control unit 60 is implemented as a push switch. When the control unit is pushed, a closed or open circuit between the circuit adaptation module 50 and the high frequency speaker 30 is controlled, to control turn-on or turn-off of the high frequency speaker 30. Further, the control unit 60 may also be implemented as a step/stepless push switch, a micro switch, a dip switch, a slide switch, or a touch switch. The above description is only intended for exemplification but not for limitation.

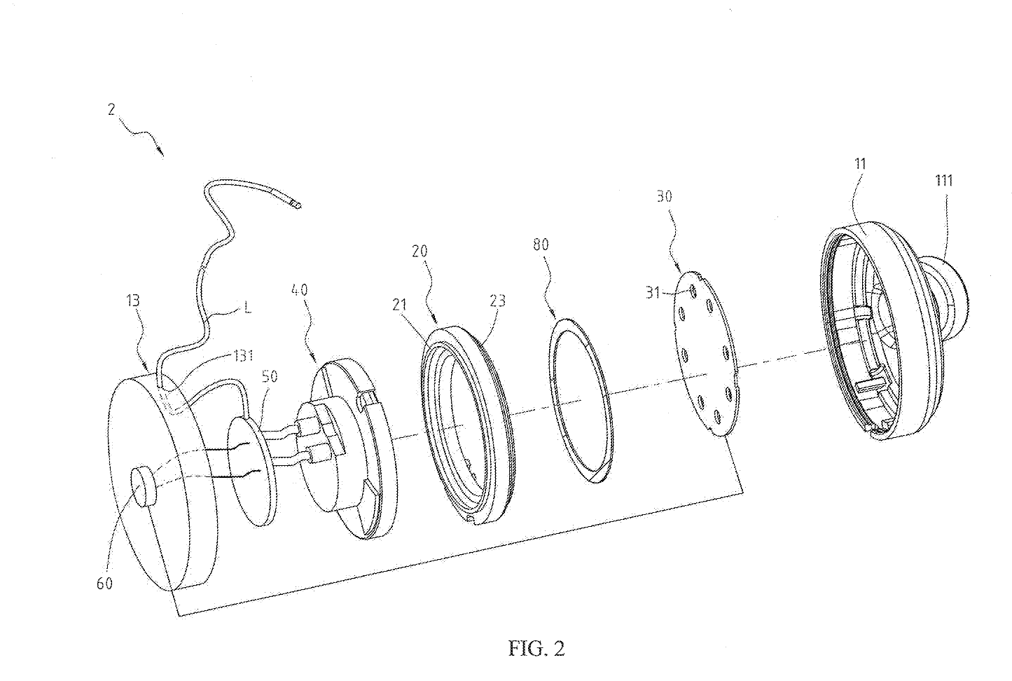

Referring to FIG. 2, an exploded view of a range switching earphone according to a second embodiment of the instant disclosure is shown. As shown in FIG. 2, the range switching earphone 2 according to the second embodiment of the instant disclosure has a similar structure as that according to the first embodiment, except that the disposing manner of the control unit 60 is different. The control unit 60 of the range switching earphone 2 according to the second embodiment of the instant disclosure is disposed on the earphone housing 10 and more specifically, on the second housing 13, and is electrically connected to the circuit adaptation module 50 and the high frequency speaker 30. As such, a user can wear the range switching earphone 2 and push an outer side of the earphone housing with a finger to achieve the effect of switching the high frequency speaker.

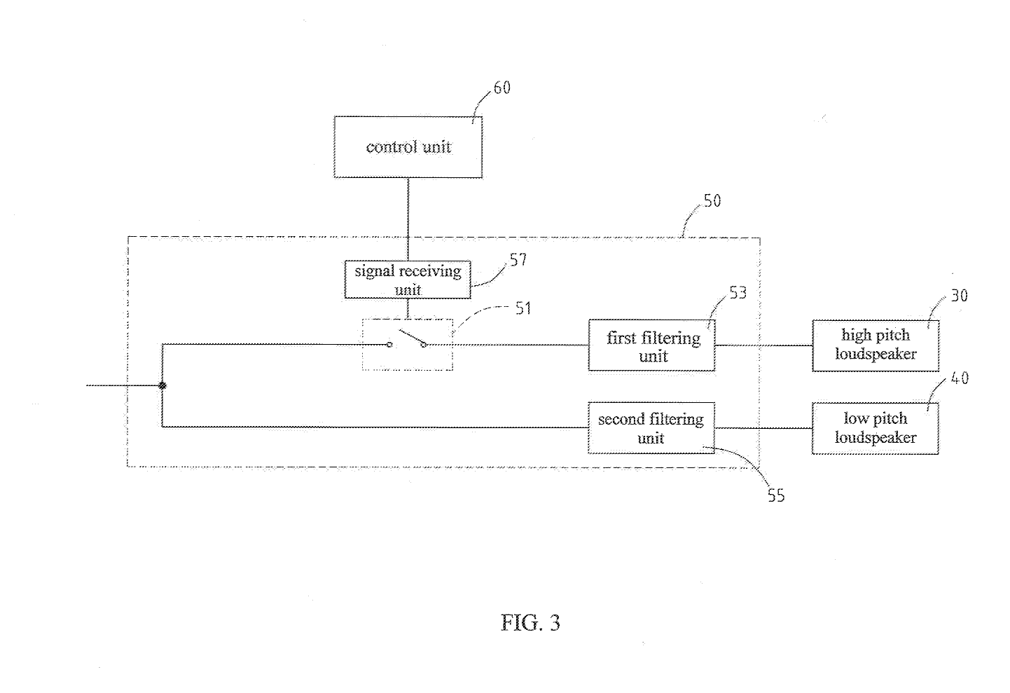

Referring to FIG. 3 to FIG. 6, schematic diagrams of units of range switching earphones according to the first embodiment to a fourth embodiment of the instant disclosure are shown. As shown in FIG. 3 to FIG. 6, the range switching earphone according to the instant disclosure simply presents a relationship among a circuit adaptation module 50, a high frequency speaker 30, a low frequency speaker 40, and a control unit 60 in a unit structure. The circuit adaptation module 50 may be actually implemented as a printed circuit board, which is driven by being connected to an external signal source (not shown) through the connection L to actuate the high frequency speaker 30 and/or the low frequency speaker 40.

As shown in FIG. 3, based on the structure in the embodiment in FIG. 1, the circuit adaptation module 50 includes a switch unit 51 and a signal receiving unit 57, where open or close of the switch unit 51 is controlled through an electrical signal. The signal receiving unit 57 is electrically connected to the control unit 60 and the switch unit 51. When the control unit 60 is pushed or toggled, a switching signal is generated. The signal receiving unit 57 receives the switching signal and controls turn-on or turn-off of the switch unit 51, to switch a connection of the circuit adaptation module 50 and the high frequency speaker 30 between an open and closed circuit. Moreover, the circuit adaptation module 50 further includes a first filtering unit 53 and a second filtering unit 55, where the first filtering unit 53 is electrically connected to the high frequency speaker 30 and the second filtering unit 55 is electrically connected to the low frequency speaker 40. The first filtering unit 53 and the second filtering unit 55 may be high-pass filters or low-pass filters, to filter certain frequency wave bands. The first filtering unit 53 and the second filtering unit 55 may be implemented as a resistance-capacitance (RC) circuit, a resistance-inductance (RL) circuit, or a resistance-inductance-capacitance (RLC) circuit.

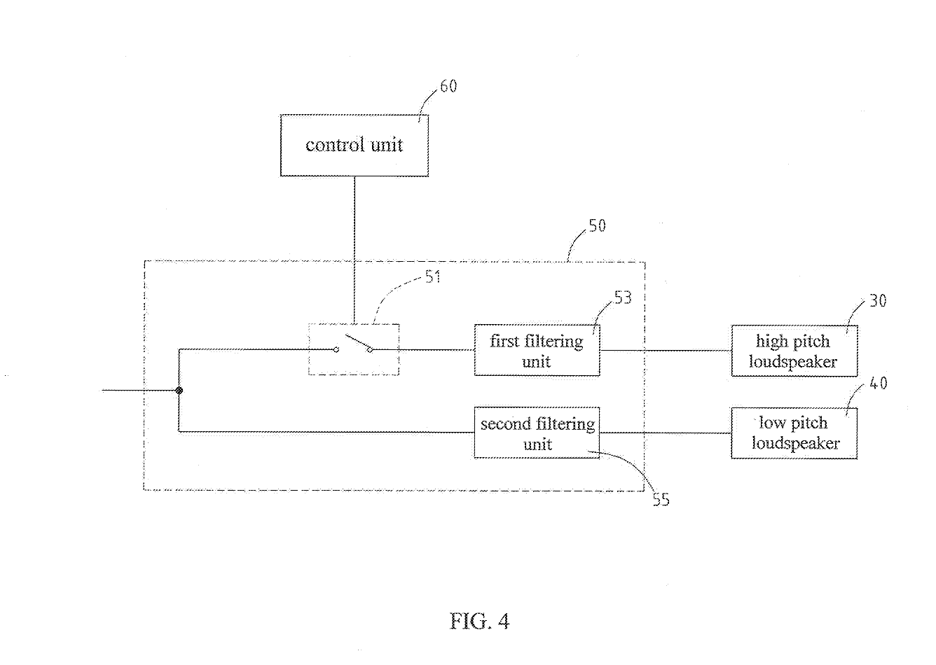

As shown in FIG. 4, based on the structure in the embodiment in FIG. 2, the switch unit 51 is controlled mechanically. The switch unit 51 may be directly connected to the control unit 60. The control unit 60 is pushed or toggled to control turn-on or turn-off of the switch unit 51, to control a connection of the circuit adaptation module 50 and the high frequency speaker 30 between an open and closed circuit. When the high frequency speaker 30 is turned on, responses in mid and high frequency regions can be complemented, thereby achieving the effects of a wider range and a high resolution. The resolution of the whole sound can be improved, thereby satisfying users liking classical music or accustomed to listening music from a certain musical instrument. Meanwhile, the control unit 60 is switched in a pushing manner so that the low frequency speaker 40 is turned on while the high frequency speaker 30 is turned off. In this case, the mid and high frequencies are reduced, the range is narrowed, and a low pitch is enhanced in an instant auditory effect, thereby satisfying requirements of game players.

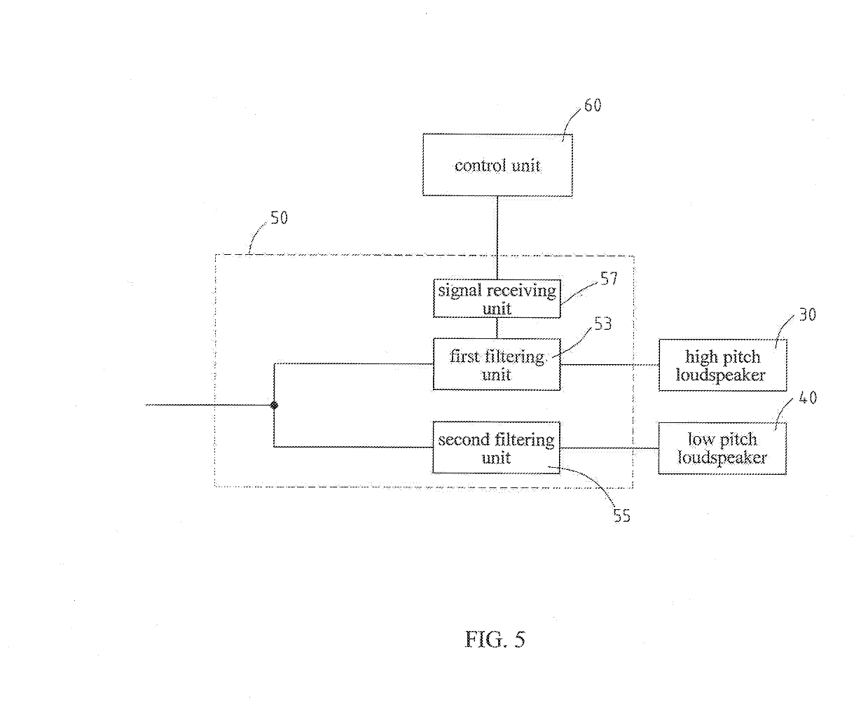

As shown in FIG. 5, the structure in the third embodiment corresponds to the structure in the embodiment in FIG. 1. However, the adaptation manner is different from that in the first embodiment and the second embodiment. The circuit adaptation module 50 includes a first filtering unit 53, a second filtering unit 55, and a signal receiving unit 57. The first filtering unit 53 and the second filtering unit 55 are connected to the high frequency speaker 30 and the low frequency speaker 40 respectively. The first filtering unit 53 has a filtering mode and a non-filtering mode. The signal receiving unit 57 is electrically connected to the control unit 60 and the first filtering unit 53. When the control unit 60 is pushed or toggled, a switching signal is generated. The signal receiving unit 57 receives the switching signal and controls the first filtering unit 53 to switch between the filtering mode and the non-filtering mode. For example, when the first filtering unit 53 is originally in the filtering mode, after receiving the switching signal, the signal receiving unit 57 controls the first filtering unit 53 to be in the non-filtering mode. In this manner, open or close of a connection between the circuit adaptation module 50 and the high frequency speaker 30 is not changed, and instead, a range switching effect is achieved by a manner of switching whether to filter a certain voice band through an electrical signal. For example, if the first filtering unit 53 is a high-pass filter, a wave band with low frequencies is filtered in the filtering mode, and not filtered in the non-filtering mode, thereby enhancing the low frequency part.

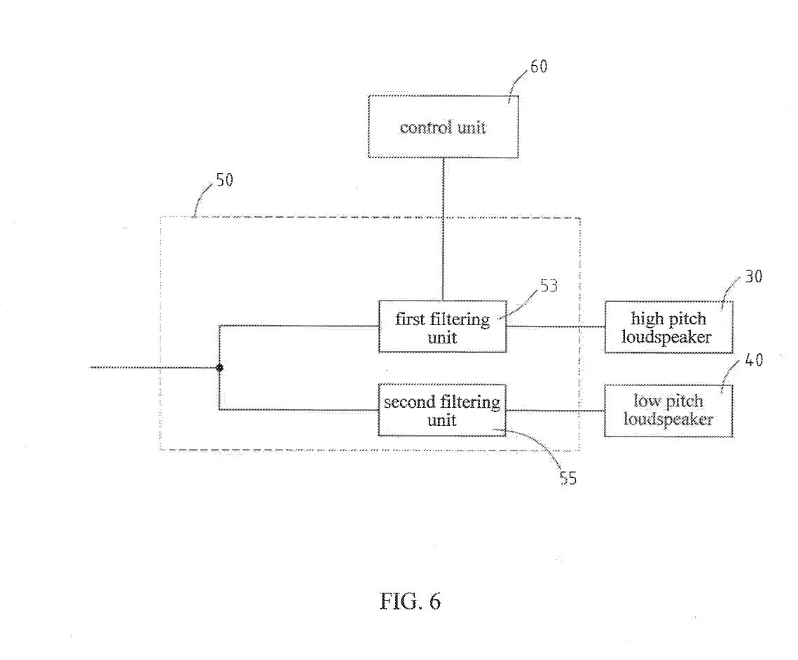

As shown in FIG. 6, based on the structure in the embodiment in FIG. 2, the first filtering unit 53 is controlled mechanically. The first filtering unit 53 may be directly connected to the control unit 60. The control unit is pushed or toggled to control the first filtering unit 53 to switch between the filtering mode and the non-filtering mode, so as to control whether to filter a certain frequency wave band. The control unit 60 may also be implemented as a step/stepless push switch, a micro switch, a dip switch, a slide switch, or a touch switch.

The objective of the instant disclosure is to provide a user with switching selection, for controlling turn-on or turn-off of the high frequency speaker or controlling the filtering unit to be in the filtering mode or the non-filtering mode, thereby adjusting the frequency range. Therefore, different frequency response can be achieved with the same earphone, thereby satisfying requirements or tastes of users for listening music of different styles or in different circumstances.

The preferred embodiments of the instant disclosure are disclosed above, and are not intended to limit the instant disclosure. Any persons skilled in the art can make some changes or modifications without departing from the spirit and scope of the instant disclosure. Therefore, the scope of the instant disclosure should be subject to the claims attached to the specification.

What is claimed is:

1. A range switching earphone, comprising:
an earphone housing;
a low frequency speaker in the earphone housing;
a high frequency speaker in the earphone housing;
a circuit adaptation module electrically connected to the low frequency speaker and the high frequency speaker; and
a control unit connected to the circuit adaptation module, for controlling turn-on or turn-off of the high frequency speaker.

2. The range switching earphone according to claim 1, wherein the circuit adaptation module includes a switch unit, and the control unit controls turn-on or turn-off of the switch unit to switch a connection of the circuit adaptation module and the high frequency speaker between an open and closed circuit.

3. The range switching earphone according to claim 1, wherein the circuit adaptation module includes a signal receiving unit and a switch unit, wherein the signal receiving unit is connected to the control unit and the switch unit, so that the control unit is activated to generate a switching signal, and the signal receiving unit receives the switching signal and controls turn-on or turn-off of the switch unit, to switch a connection of the circuit adaptation module and the high frequency speaker between an open and closed circuit.

4. The range switching earphone according to claim 1, wherein the control unit is disposed on the earphone housing.

5. The range switching earphone according to claim 2, wherein the control unit is disposed on the earphone housing.

6. The range switching earphone according to claim 1, wherein the circuit adaptation module is further connected to a connection line, a control bar is disposed on the connection line, and the control unit is disposed on the control bar.

7. The range switching earphone according to claim 2, wherein the circuit adaptation module is further connected to a connection line, a control bar is disposed on the connection line, and the control unit is disposed on the control bar.

8. The range switching earphone according to claim 3, wherein the circuit adaptation module is further connected to a connection line, a control bar is disposed on the connection line, and the control unit is disposed on the control bar.

9. The range switching earphone according to claim 1, wherein the control unit is a push switch, a touch switch, or a dip switch.

10. The range switching earphone according to claim 1, further comprising a holder, wherein the earphone housing includes a first housing and a second housing, the first housing includes an in-ear portion, the first housing is combined with the second housing, the holder is disposed in the earphone housing and connected to the first housing or the second housing, the low frequency speaker is connected to a first side of the holder, the high frequency speaker is connected to a second side of the holder, the second side is opposite to the first side and faces the in-ear portion, and the high frequency speaker includes a plurality of voice penetrating holes.

11. The range switching earphone according to claim 10, wherein the high frequency speaker is a piezoelectric ceramic loudspeaker, and the voice penetrating holes are annularly arranged on the high frequency speaker.

12. A range switching earphone, comprising:
an earphone housing;
a low frequency speaker disposed in the earphone housing;
a high frequency speaker disposed in the earphone housing;
a circuit adaptation module electrically connected to the low frequency speaker and the high frequency speaker and including a filtering unit, wherein the filtering unit is electrically connected to the high frequency speaker and has a filtering mode and a non-filtering mode; and
a control unit connected to the filtering unit, for selectively controlling the filtering unit to be in the filtering mode or the non-filtering mode.

13. The range switching earphone according to claim 12, wherein the circuit adaptation module further includes a signal receiving unit, and the signal receiving unit is connected to the control unit and the filtering unit, so that when the control unit acts, a switching signal is generated, and the signal receiving unit receives the switching signal and controls the filtering unit to switch between the filtering mode and the non-filtering mode.

14. The range switching earphone according to claim 12, wherein the circuit adaptation module is further connected to a connection line, a control bar is disposed on the connection line, and the control unit is disposed on the control bar.

15. The range switching earphone according to claim 13, wherein the circuit adaptation module is further connected to a connection line, a control bar is disposed on the connection line, and the control unit is disposed on the control bar.

16. The range switching earphone according to claim 12, wherein the control unit is a push switch, a touch switch, or a dip switch.

17. The range switching earphone according to claim 12, wherein the control unit is disposed on the earphone housing.

18. The range switching earphone according to claim 12, further comprising a holder, wherein the earphone housing includes a first housing and a second housing, the first housing includes an in-ear portion, the first housing is combined with the second housing, the holder is disposed in the earphone housing and connected to the first housing or the second housing, the low frequency speaker is connected to a first side of the holder, the high frequency speaker is connected to a second side of the holder, the second side is opposite to the first side and faces the in-ear portion, and the high frequency speaker includes a plurality of voice penetrating holes.

19. The range switching earphone according to claim 18, wherein the high frequency speaker is a piezoelectric ceramic loudspeaker, and the voice penetrating holes are annularly arranged on the high frequency speaker.
